(19) United States
(12) Patent Application Publication
(10) Pub. No.: US 2026/0043149 A1
(43) Pub. Date: Feb. 12, 2026

(54) MEMBRANE ELECTROLYZER WITH CATHODE WATER FLOW IN OPPOSITE DIRECTION TO ANODE WATER FLOW

(71) Applicant: ELECTRIC HYDROGEN CO., Devens, MA (US)

(72) Inventors: David EAGLESHAM, Lexington, MA (US); Jigish TRIVEDI, Pleasanton, CA (US); Nemanja DANILOVIC, El Sobrante, CA (US); Elif KARATAY, Mountain View, CA (US); Adam LIBERT, Pacifica, CA (US)

(21) Appl. No.: 19/099,298

(22) PCT Filed: Aug. 23, 2023
(86) PCT No.: PCT/US2023/030978

§ 371 Date: Jan. 28, 2025

Related U.S. Application Data
(60) Provisional application No. 63/400,675, filed on Aug. 24, 2022.

(51) Int. Cl. C25B 1/04; C25B 9/70; C25B 13/02; C25B 15/08

(52) U.S. Cl. CPC C25B 1/04; C25B 9/70; C25B 13/02; C25B 15/08

(57) ABSTRACT

The following disclosure relates to an electrochemical cell or system that is configured to operate with forced water flow on the cathode side of the cell and forced water flow on the anode side of the cell. The system may include at least one electrochemical cell having a cathode, an anode, and a membrane separating the cathode and the anode. The system has the forced water flow on the cathode side of the cell to be principally in opposite direction of the forced water flow on the anode side of the cell.

The present patent document claims the benefit of United States Provisional Ser. No. 63/400,675 , filed Aug. 24, 2022, which is hereby incorporated by reference in its entirety.

### FIELD

The following disclosure relates to electrochemical or electrolysis cells and components thereof. More specifically, the following disclosure relates to electrochemical cells configured with active forced water flow on both cathode and anode sides of the cell or stack.

### BACKGROUND

An electrolysis cell or system uses electrical energy to drive a chemical reaction. For example, water is split to form hydrogen and oxygen. The products may be used as energy sources for later use. In recent years, improvements in operational efficiency have made electrolyzer systems competitive market solutions for energy storage, generation, and/or transport. For example, the cost of generation may be below $10 per kilogram of hydrogen in some cases. Increases in efficiency and/or improvements in operation will continue to drive the installation of electrolyzer systems.

Thermal designs impose limitations on the ability to scale electrolyzer systems to higher power density, thinner membranes (e.g., micrometer thickness), and larger cell areas. Therefore, there remains a need for an improved thermal design, allowing for the ability to scale electrolyzer systems.

### SUMMARY

In one embodiment, an electrochemical system is provided. The electrochemical system includes at least one electrochemical cell, wherein each electrochemical cell of the at least one electrochemical cell includes a cathode, an anode, and a membrane separating the cathode and the anode. The electrochemical system has an operating forced water flow on the cathode side of the cell and an operating forced water flow on the anode side of the cell. In addition, the electrochemical system is configured to operate with the forced water flow on the cathode side of the cell to be principally in opposite direction of the forced water flow on the anode side of the cell.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Exemplary embodiments are described herein with reference to the following drawings.

FIG. 1 depicts an example of an electrochemical cell.

FIG. 2 depicts an additional example of an electrochemical cell.

FIG. 3 depicts an example of a simplified system including an electrochemical stack having a plurality of electrochemical cells of FIG. 1 or 2.

FIG. 4 depicts an additional example of a section of a system having an electrochemical stack.

FIG. 5 depicts an example of an electrochemical cell having a counter-current water flow arrangement on the anode and cathode sides of the cell.

FIG. 6 depicts an example of a temperature profile of water in a counter-current water flow arrangement across an electrochemical cell, such as depicted in FIG. 5.

FIG. 7 depicts an example of a thermal model of a temperature distribution in a cell having a counter-current water flow arrangement such as depicted in FIG. 5 or 6.

While the disclosed compositions and methods are representative of embodiments in various forms, specific embodiments are illustrated in the drawings (and are hereafter described), with the understanding that the disclosure is intended to be illustrative and is not intended to limit the claim scope to the specific embodiments described and illustrated herein.

### DETAILED DESCRIPTION

The following disclosure provides an improved electrochemical system and method for operating an electrochemical system with water flow on the cathode and anode sides of a cell or stack of the system in a counter-current flow configuration. The implementation of such a counter-current water flow across the cell or stack advantageously provides improved thermal control of the cell membrane temperature. Additionally, such a counter-current water flow arrangement may advantageously provide a reduction in an overall amount of fluid flow or water flow required to maintain the temperature of the membrane(s) of the cell(s) in the system within a specified temperature range, therein providing a potential cost savings on water usage.

Additionally, the counter-current water flow configuration may also provide additional advantages for effectively cooling larger current density (e.g., at least 3 Amps/cm²) operating conditions, thinner cell membranes (e.g., less than 1000 microns), and larger scale membrane reaction/surface areas (e.g., at least 500 cm²). Specifically, operating a cell or stack at a higher current density, at larger scale reaction areas, and with thinner membranes, the amount of heat generated within the cell due to the water splitting reaction is significant and requires more water to cool and maintain a desirable temperature within the cell and at the membrane. Implementation of a counter-current water flow configuration may address these challenges and effectively control the temperature within the cell using less water than conventional electrochemical stack designs.

### Electrochemical Cells

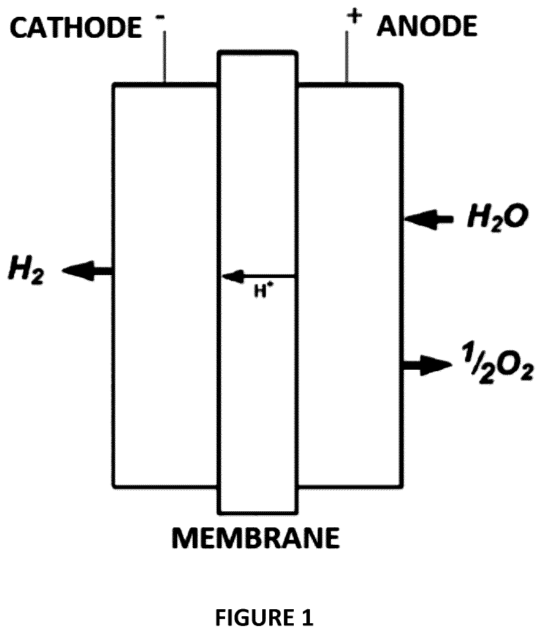

FIG. 1 depicts an example of an electrochemical cell for hydrogen gas and oxygen gas production through the splitting of water. The electrochemical cell includes a cathode, an anode, and a membrane positioned between the cathode and anode. The membrane may be a proton exchange membrane (PEM) or an anion exchange membrane (AEM). Proton Exchange Membrane (PEM) electrolysis involves the use of a solid electrolyte or ion exchange membrane. Within the water splitting electrolysis reaction, one interface runs an oxygen evolution reaction (OER) while the other interface runs a hydrogen evolution reaction (HER). For example, the anode reaction is H₂O→2H⁺+½O₂+2e and the cathode reaction is 2H⁺+2e→H₂. The water electrolysis reaction has recently assumed great importance and renewed attention as a potential foundation for a decarbonized “hydrogen economy.”

Because the performance of a single electrochemical cell may not be adequate for many use cases, multiple cells may be placed together to form a “stack” of cells, which may be referred to as an electrolyzer stack, electrochemical stack, electrochemical stack, or simply just a stack. In certain examples, a stack may contain 50-1000 cells, 50-100 cells, 500-700 cells, or more than 1000 cells. Any number of cells may make up an electrochemical stack.

The electrochemical cells within the electrochemical stack may be configured to operate with 200 mV or less of pure resistive loss when operating at a high current density (e.g., at least 3 Amps/cm², at least 4 Amps/cm², at least 5 Amps/cm², at least 6 Amps/cm², at least 7 Amps/cm², at least 8 Amps/cm², at least 9 Amps/cm², at least 10 Amps/cm², in a range of 3-15 Amps/cm², or in a range of 5-10 Amps/cm²).

Further, the electrochemical cells within the electrochemical stack may be used in the formation of a large-scale electrochemical plant that may be configured to generate at least 1 megawatt (MW) of power, at least 5 MW, at least 10 MW, at least 25 MW, at least 50 MW, at least 75 MW, at least 100 MW, in a range of 1-100 MW, in a range of 10-100 MW, in a range of 25-100 MW, or in a range of 50-100 MW of power.

In additional examples, the amount of water (e.g., deionized (DI) water) transferred to or circulated through each cell of the stack may be in a range of 0.25-5 mL/Amp/cell/min.

Further, because protons are bound to water, each H⁺ carries several water molecules across the membrane in a process called electro-osmotic drag. The amount of water is around 3 H₂O per proton or about 6 H₂O per H₂ molecule. As a result, there is no need to supply the cathode with any additional water. In PEM electrolysis system designs, water flows into the anode side, and mixed water/oxygen gas flows out of the anode, but the cathode side has no inlet and wet hydrogen flowing out of the outlet. Small lab test cells designed to allow both fuel-cell and electrolysis operation may allow flow on the cathode side (since this is required in Fuel Cell mode), but there are no large electrolysis systems that use forced water flow on the cathode side.

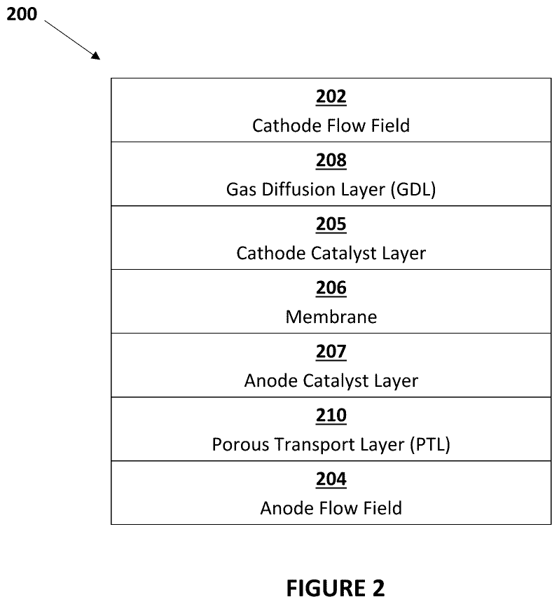

FIG. 2 depicts an additional example of an electrochemical or electrolytic cell. Specifically, FIG. 2 depicts a portion of an electrochemical cell 200 having a cathode flow field 202, an anode flow field 204, and a membrane 206 positioned between the cathode flow field 202 and the anode flow field 204.

In certain examples, the membrane 206 may be a catalyst coated membrane (CCM) having a cathode catalyst layer 205 and/or an anode catalyst layer 207 positioned on respective surfaces of the membrane 206. As used throughout this disclosure, the term “membrane” may refer to a catalyst coated membrane (CCM) having such catalyst layers. In certain examples, the membrane 206 (that, in some examples, may include the anode catalyst layer 207 and cathode catalyst layer 205) may have an overall thickness that is less than 1000 microns, less than 500 microns, less than 250 microns, less than 125 microns, less than 100 microns, less than 50 microns, less than 10 microns, less than 5 microns, in a range of 5-1000 microns, in a range of 5-500 microns, in a range of 5-250 microns, in a range of 5-125 microns, or in a range of 5-100 microns.

In certain examples, additional layers may be present within the electrochemical cell 200. These additional layers may include porous media sandwiching the CCM and configured to facilitate the transport of fluids (i.e., water to the electrodes and gases from the electrodes) as well as provide electrical conductivity to the electrodes.

For example, one or more additional layers 208 may be positioned between the cathode flow field 202 and membrane 206. In certain examples, this may include a gas diffusion layer (GDL) 208 may be positioned between the cathode flow field 202 and membrane 206. This may be advantageous in providing a hydrogen diffusion barrier adjacent to the cathode on one side of the multi-layered membrane to mitigate hydrogen crossover to the anode side. In other words, the GDL is a porous media responsible for the transport of gaseous hydrogen to the cathode side flow field. For a wet cathode PEM operation, liquid water transport across the GDL is needed for heat removal in addition to heat removal from the anode side. In certain examples, the GDL 208 may be made of carbon fibers. In certain examples, the thickness of the GDL 208 may be in a range of 100-1000 microns.

Similarly, one or more additional layers 210 may be present in the electrochemical cell between the membrane 206 and the anode 204. In certain examples, this may include a porous transport layer (PTL) positioned between the membrane 206 (e.g., the anode catalyst layer 207 of the catalyst coated membrane 206) and the anode flow field 204.

Similar to the GDL, the PTL is a porous media configured to allow the transportation of the reactant water to the anode catalyst layers, remove produced oxygen gas, and provide good electrical conductivity for effective electron conduction. In other words, liquid water flowing in the anode flow field is configured to permeate through the PTL to reach the CCM. Further, gaseous byproduct oxygen is configured to be removed from the PTL to the flow fields. In such an arrangement, liquid water functions as both reactant and coolant on the anode side of the cell.

In certain examples, the thickness of the PTL may be in a range of 100-1000 microns. The thickness of the PTL may affect the mass transport within the cell as well as the durability/deformability and electrical/thermal conductivity of the PTL. In other words, thinner PTLs compared to thicker PTLs (e.g., 1 mm) may provide better mass transport. However, when the PTL is too thin (e.g., less than 100 microns), the PTL may suffer from poor two phase flow effects as well. PTLs are less prone to deformation compared to GDLs. Thickness of PTLs may also affect lateral electron conduction resistance along the lands in between channels.

The cathode flow field 202 and anode flow field 204 of the cell may individually include a flow field plate composed of metal, carbon, or a composite material having a set of channels machined, stamped, or etched into the plate to allow fluids to flow inward toward the membrane or out of the cell.

### Electrochemical Stacks and Systems With Counter-Current Water Flow

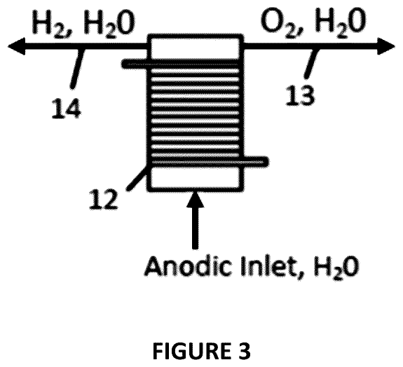

As illustrated in a simplified example of an electrochemical system in FIG. 3, water (H₂O) may be supplied to the anodic inlet of an electrochemical cell stack 12. In some embodiments, only the anodic inlet of the cell stack 12 may receive water. In these embodiments, the cathode side of the cell stack 12 may not receive water (e.g., a dry cathode side may be used). In another embodiment not shown in FIG. 3, a cathode inlet may also receive water, wherein the water may be supplied to the cathode inlet to cool the cell stack 12 during electrolysis.

The water supplied to the anodic inlet flows to an anodic inlet manifold that distributes the water to the anode side of the plurality of cells contained with the cell stack 12. In embodiments where water is supplied to the cathode inlet, water supplied to the cathode inlet flows to a cathodic inlet manifold that distributes the water to the cathode side of the plurality of cells in the cell stack 12.

During electrolysis, oxygen (O₂) is produced at the anode side of the electrochemical cells and hydrogen (H₂) is produced at the cathode side of the electrochemical cells. Specifically, a water splitting electrolysis reaction is configured to take place within each individual cell in the cell stack 12. Each cell includes one interface (the anode side of the cell) configured to run an oxygen evolution reaction (OER) and another interface (the cathode side of the cell) configured to run a hydrogen evolution reaction (HER), such as depicted in FIG. 1.

During electrolysis, some of the water supplied to the anode side of an electrochemical cell may not be converted into oxygen. Accordingly, a two-phase flow of oxygen and unreacted water is outlet from each of the anode sides of the cells into an anodic outlet manifold 13. The two-phase flow of oxygen and unreacted water flows from out of the cell stack 12 through the anodic outlet manifold 13.

Additionally, as noted above, in some embodiments, water may be supplied to the cathode side of the cell stack as a coolant. Accordingly, a two-phase flow of hydrogen and water is outlet from each of the cathode sides of the cells to a cathodic outlet manifold 14. The two-phase flow of hydrogen and water flows out of the cell stack 12 through the cathodic outlet manifold 14.

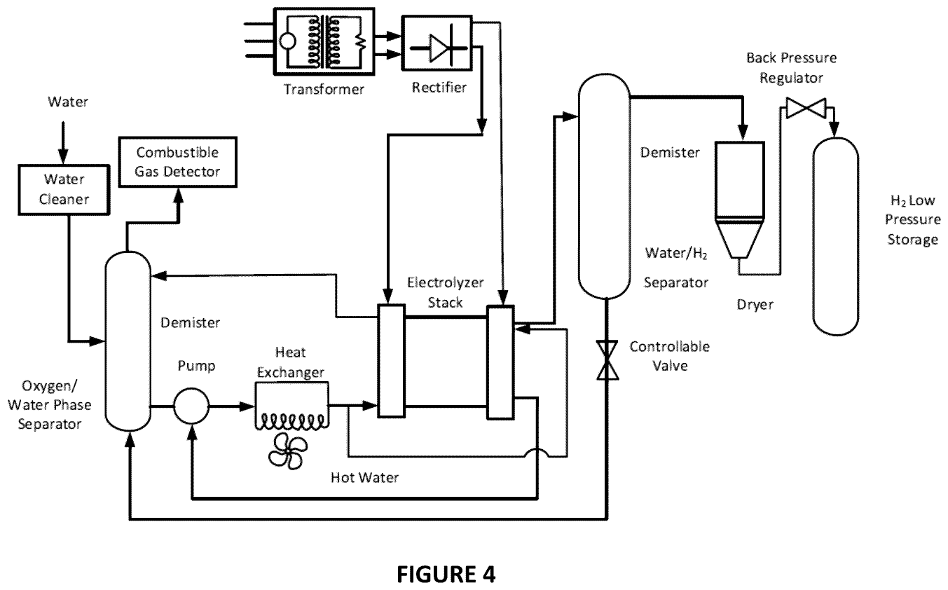

FIG. 4 depicts a more detailed example of an electrolysis system for producing hydrogen gas and oxygen gas from water. The system includes an electrolyzer stack including a plurality of electrochemical cells. The stack is configured to receive a first supply of water through an anodic inlet and a second supply of water through a cathodic inlet. As discussed in greater detail below, the flow of water through the anodic inlet may advantageously be in a counter-current arrangement in relation to the flow of water through the cathodic inlet.

The system further includes an anodic outlet at the stack and a cathodic outlet at the stack. The anodic outlet is configured to transfer oxygen produced in the water splitting reaction as well as heated water out of the stack. Further, the cathodic outlet is configured to transfer hydrogen gas produced in the water splitting reaction as well as heated water out of the stack.

Additionally, within the system depicted in FIG. 4, the water for the first supply of water to the anodic inlet and the second supply of water to the cathodic inlet is provided from at least one water source. A water cleaner may be provided within the system to filter out any impurities within the source prior to its transfer to the stack. The treated water may be transferred to an oxygen/water phase separator configured to also receive unreacted water and generated oxygen from the anodic side of the electrolyzer stack, as well as water separated out from a water/hydrogen separator from the cathodic side of the stack.

The water separated from the oxygen/water phase separator may be transferred to at least one pump and at least one heat exchanger. The pump may be configured to provide a forced/controlled flow of water to both the anodic and cathodic inlets. Alternatively, a first pump may be configured to provide a first flow of water to the anodic inlet, while a second, separate pump is provided to provide a second flow of water to the cathodic inlet. The at least one heat exchanger may be configured to control the temperature of the water to the anodic and/or cathodic inlets.

Following the heat exchanger, the water may be separated or diverted into two streams to provide the forced, temperature-controlled water flow to both sides (anodic and cathodic sides) of the electrolyzer stack. The separation of the streams may be configured to provide a specified flow rate to the anodic inlet and a specified flow rate to the cathodic inlet that may be the same as or different from the flow rate to the anodic inlet. In some cases, the flow rate to the cathodic inlet is less than the flow rate to the anodic inlet. For example, the water flow rate on the cathode side may be configured to be at least 1% of the water flow rate on the anode side, at least 5%, at least 10%, at least 20%, at least 25%, or at least 50% of the flow rate on the anode side. In other examples, the water flow rate on the cathode side may be configured to be in a range of 1-50% of the water flow rate on the anode side, in a range of 1-25%, in a range of 1-20%, in a range of 1-10%, in a range of 5-25%, in a range of 5-20%, or in a range of 5-10% of the water flow rate on the anode side. In other examples, the water to the cathodic inlet of the cell/stack may be 0% of the water flow rate on the anode side such that cathodic inlet to the cell/stack is closed off and only water flows to the anodic inlet. This may take place during start-up or shutdown of the cell/stack, for example.

Following the water splitting reaction within the stack, the generated oxygen and unreacted (heated) water on the anodic side of the stack is returned to the oxygen/water phase separator, while the generated hydrogen and (heated) water is send to a water/hydrogen separator.

Within the water/hydrogen separator, hydrogen is separated and may be transferred to a dryer to remove further entrapped water before being transferred to a hydrogen low pressure storage facility.

As noted above, separated water from the water/hydrogen separator is recycled back to the oxygen/water separator for further use.

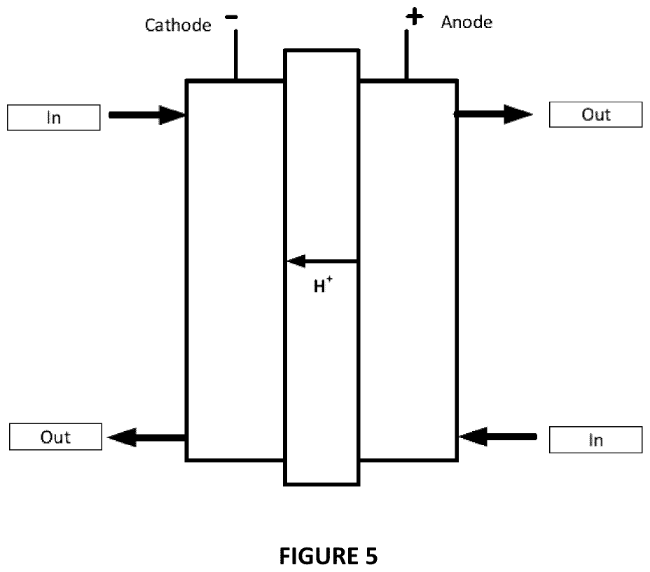

For simplicity, FIG. 5 provides an illustration of the counter-current flow arrangement for the electrochemical stack within FIG. 4 for a single electrochemical cell of the stack. In this example, the cells within the stack are configured to receive a first supply of water through an anodic inlet and through a second supply of water through a cathodic inlet.

In the example of the electrochemical cell in FIG. 5, the electrochemical cell includes a cathode, an anode, and a membrane positioned between the cathode and anode. The membrane may be a proton exchange membrane (PEM) or an anion exchange membrane (AEM). The electrochemical cell is configured to include an inlet and outlet on both the anode side and on the cathode side of the cell. In this example, the system is configured to have forced water flow on both the anode side and the cathode side of the cell in a counter-current arrangement for the production of hydrogen gas and oxygen gas through the splitting of water.

The cathodic outlet, as depicted in FIG. 5, is configured to transfer the hydrogen gas produced from the electrochemical cells to further downstream components for further processing. In addition, as noted above, the cathodic outlet may also transfer the heated water out of the stack. In certain configurations, a water byproduct is also provided at the cathodic outlet (wherein the water may be used as a coolant for the hydrogen gas produced). Additional downstream components following the cathodic outlet are not depicted in FIG. 5, but may include water-gas separators, purifiers, heat exchangers, circulation pumps, pressure regulators, electro-mechanical sensors, valves, etc. For example, in FIG. 4, a cathodic pressure regulator is depicted at the cathodic outlet. This pressure regulator may be positioned further downstream from the cathodic outlet after one or more further components such as a water-gas separator or purifier.

Further, as depicted in FIG. 5, the electrolysis system includes an anodic outlet that transfers the oxygen gas produced from the electrochemical cells within the stack as well as unreacted water byproduct to further downstream components for further processing. Again, the additional downstream components following the anodic outlet are not depicted in FIG. 3, but may include water-gas separators, purifiers, heat exchangers, circulation pumps, pressure regulators, electro-mechanical sensors, valves, etc., such as those features depicted in the example of FIG. 3.

As noted above, in the examples in FIGS. 4 and 5, the forced water flow on the cathode side of the cell is advantageously configured to have a counter-current flow arrangement, wherein the flow on the cathode side is in an opposite direction of the forced water flow on the anode side of the cell. For instance, cool forced water is provided at both the inlet of the anode and at the inlet of the cathode, wherein the inlets are positioned in opposite directions at opposite ends of the cell. As the cool forced water flows across the membrane, the heat generated in the water splitting reaction within the electrolysis cell is transferred to the forced water flow, therein cooling or maintaining a reaction temperature within the cell, and the now heated forced water is exited out of the outlets of the anode and cathode sides.

This counter-current forced water flow on both the cathode and anode sides of the cell/stack is advantageous in improving thermal control of the stack. Specifically, by averaging the temperature of the cathode and anode water temperatures at a particular location of the membrane, the membrane now sees a same or similar temperature across the membrane. This may permit for a larger change in temperature in the water (e.g., lower flow at a given membrane current density or power) while maintaining a much smaller change in temperature of the membrane. This is advantageous by providing improved temperature control of the membrane by ensuring that the average water temperature seen by the membrane (e.g., averaging the cathode and anode water flows) can now be chosen to be constant across the whole cell (i.e., the part of the cell seeing the hottest anode water is seeing the coolest cathode water).

In other words, the average temperature at the membrane may be the same across the entire membrane. This is because the part of the membrane near the anode outlet having the hottest anode water is adjacent to the cathode inlet having the coldest cathode water. Similarly, the part of the membrane near the anode inlet having the coldest anode water is adjacent to the cathode outlet having the hottest cathode water. This balancing or averaging between the hot outlet and cold inlet streams in the counter-current water flow arrangement therein allows for an average temperature at the membrane throughout the cell.

As noted above, this counter-current water flow arrangement is particularly advantageous for higher current density cell operations, for cells having thinner membranes, and/or for cells having larger membrane reaction/surface areas. Specifically, under higher current density operations (e.g., cells configured to operate with 200 mV or less of pure resistive loss when operating at a current densities of at least 3 Amps/cm², at least 4 Amps/cm², at least 5 Amps/cm², at least 6 Amps/cm², at least 7 Amps/cm², at least 8 Amps/cm², at least 9 Amps/cm², at least 10 Amps/cm², in a range of 3-15 Amps/cm², or in a range of 5-10 Amps/cm²), the amount of heating within the cell due to the water splitting reaction is significant. That is, the membrane may heat up at least 5-10° C. more than a similarly sized cell operating at a lower current density (e.g., 1-2 Amps/cm²). At lower current/power levels, the amount of water required to cool the cell or stack is lower, and the cost for the addition of a separate cathode flow stream may outweigh the cost of a reduction in water savings.

Further, the membrane resistance may additionally contribute to a further heating load, causing the membrane to potentially be up to 10° C. hotter than the water around the membrane. Specifically, joule heating of the membrane itself becomes significant for high current densities due to resistance I² (i.e., R being the nature of resistive heating). For example, at 5 Amps/cm², Joule heating may be more than six times higher than at 2 Amps/cm².

For these reasons, higher current density cell operations require more water to cool the cell and maintain a desirable temperature within the cell and at the membrane. In some examples, there may be a linear relationship between the amount of power/current density to the cell and the amount of water or flow velocity of the water needed to maintain a fixed or target temperature at the membrane (i.e., a 2× increase in current density may require a 2× increase in water flow rate through the cell).

Similarly, for larger cell designs having larger scale membrane surface areas (e.g., areas of at least 100 cm², at least 200 cm², at least 300 cm², at least 400 cm², at least 500 cm², at least 600 cm², at least 700 cm², at least 800 cm², at least 900 cm², at least 1000 cm², in a range of 100-1000 cm², or in a range of 500-1000 cm²), the water required to cool the cell also becomes significant. That is, as the cell gets larger and requires more power/current to the cell, the overall temperature increase also may become larger. This in turn requires a higher water input/flow velocity of water to maintain a fixed or target temperature at the membrane.

Additionally, for cell configurations having thinner membranes (e.g., membranes that are less than 1000 microns thick, less than 500 microns, less than 250 microns, less than 125 microns, less than 100 microns, less than 50 microns, less than 10 microns, less than 5 microns, in a range of 5-1000 microns, in a range of 5-500 microns, in a range of 5-250 microns, in a range of 5-125 microns, or in a range of 5-100 microns thick), the water required to cool the cell also becomes significant. That is, thicker membranes may act as a better thermal insulator than thinner membranes. With a thicker membrane (e.g., greater than 1000 microns), the membrane may not heat up as much as a thinner membrane (e.g., less than 1000 microns) during a similarly operated electrochemical reaction, therein requiring less water input requirements to cool the cell or stack. As such, with a thinner membrane configuration, such as certain examples proposed herein, a higher water input/flow velocity of water is needed to maintain a fixed or target temperature at the membrane.

Implementation of a counter-current water flow configuration as depicted in FIGS. 4 and 5, for example, may address these challenges and effectively improve thermal control of the temperature within the cell using less water than conventional electrochemical stack designs would require under similar operating conditions (e.g., cells or stacks not having any water input on the cathode side of the cell/stack or having a co-current flow configuration on the anode and cathode sides of the cell/stack).

Further, pressure drops across cells with higher power densities than conventional electrochemical systems, membranes that are thinner, and larger cells may increase faster than linearly. Scaling due to the flow velocity for turbulent flow (e.g., forced water flow in a given water channel geometry) provides another advantage.

In certain examples, within the counter-current water flow arrangement identified in FIGS. 4 and 5, the water flow rate on the cathode side may be equal to less than the water flow rate on the anode side. In certain examples, the water flow rate is a fraction or percentage of the water flow rate on the anode side. For example, the water flow rate on the cathode side may be configured to be at least 1% of the water flow rate on the anode side, at least 5%, at least 10%, at least 20%, at least 25%, or at least 50%. In other examples, the water flow rate on the cathode side may be configured to be in a range of 1-50% of the water flow rate on the anode side, in a range of 1-25%, in a range of 1-20%, in a range of 1-10%, in a range of 5-25%, in a range of 5-20%, or in a range of 5-10%.

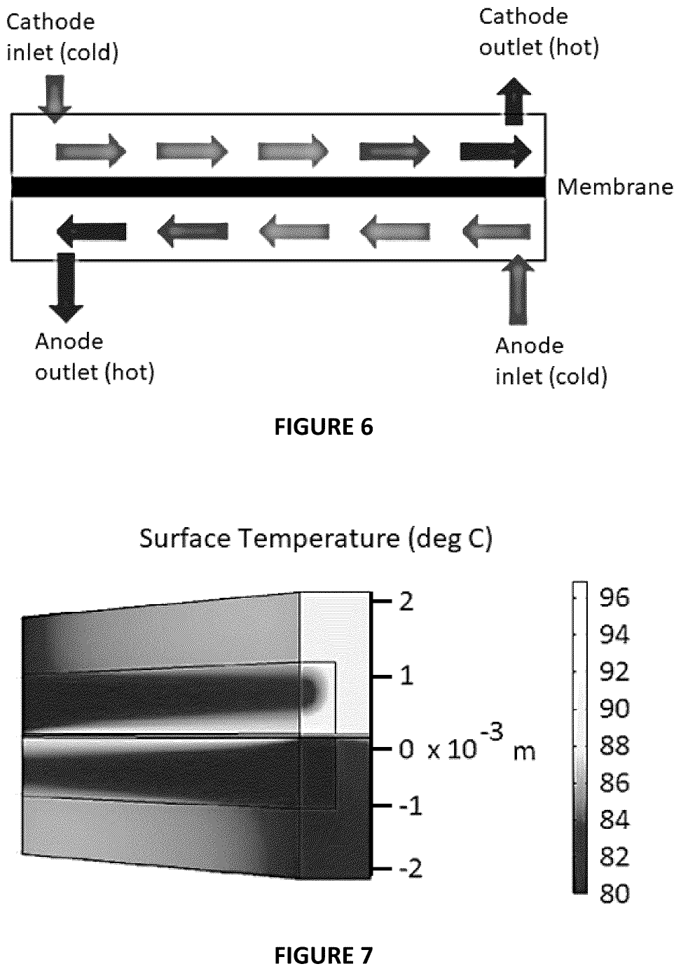

FIGS. 6 and 7 depict such an example of the improved thermal control through a counter-current flow configuration. Based on the arrangement/example in FIGS. 4 and 5, the counter-current flow arrangement in FIG. 6 depicts a cold water cathode inlet stream on the cathode side of the cell. On the opposite side of the cell, a cold water anode inlet stream is positioned on the anode side of the cell on an opposite end of the cell from the cathode inlet. Through this counter-current flow arrangement, water flowing into the anode cools down the anode side of the membrane and the heat generated from the water splitting reaction. This heat exchange continues to warm up the anode water stream before exiting the anode outlet. The same heat exchange takes place on the cathode side of the cell, in the counter-current flow arrangement. In such an arrangement, the part of the membrane near the anode outlet having the hottest anode water is adjacent to the cathode inlet having the coldest cathode water, while the part of the membrane near the anode inlet having the coldest anode water is adjacent to the cathode outlet having the hottest cathode water, therein providing an average membrane temperature throughout.

Additionally, as noted above, such a counter-current water flow arrangement may also advantageously provide a reduction in an overall amount of fluid flow or water flow required to maintain the temperature of the membrane(s) of the cell(s) in the system within a specified temperature range. Specifically, the amount of water needed to maintain a specified temperature at the membrane(s) of the cell or stack using a counter-current water flow current arrangement may be less than a similarly operating cell or stack that only has an input water flow at the inlet of the anode side of the cell/stack, or a cell/stack that is inputting water to the anode and cathode sides of the cell/stack in a co-current flow arrangement. The amount of water reduction using the counter-current flow arrangement may be at least 5% less, at least 10% less, at least 15% less, at least 20% less, or at least 25% less than the similarly operated cells/stacks with no cathode water input or a co-current water flow arrangement for the cathode and anode sides of the cell/stack.

Further, as depicted in FIG. 7, a chart is displayed showing a thermal model of the temperature distribution in a counterflow cell following the flow configuration depicted in FIG. 6. The temperature at the inlet of the anode (lower right) and the inlet of the cathode (upper left) is colder than the temperature of the water coming out of the outlet of the anode (lower left) and the outlet of cathode (upper right), solving the temperature management challenge.

As shown in FIG. 7, this counter-current forced water flow on both the cathode and anode sides of the cell/stack is advantageous in improving thermal control of the stack. Specifically, the membrane now sees a same or similar temperature across the membrane. That is, the cathodic inlet (top left) having a cold water input is adjacent to the anodic outlet (bottom left) having a hot water output. Additionally, the cathodic outlet (top right) having a hot water output is adjacent to the anodic inlet (bottom right) having a cold water input. These opposing temperature profiles advantageously provide an average temperature at the membrane that is the same or similar at both the anodic inlet/cathodic outlet and the anodic outlet/cathodic inlet locations.

This may permit for a larger change in temperature in the water (e.g., lower flow at a given membrane current density or power) while maintaining a much smaller change in temperature of the membrane. In other words, this arrangement provides for the ability to have a larger temperature profile (delta T) across the cell (i.e., between the anodic inlet/cathodic outlet or the anodic outlet/cathodic inlet locations) while maintaining a much smaller temperature profile (delta T) at the membrane. This is advantageous by providing improved temperature control of the membrane by ensuring that the average water temperature seen by the membrane (e.g., averaging the cathode and anode water flows) can now be chosen to be constant across the whole cell (i.e., the part of the cell seeing the hottest anode water is seeing the coolest cathode water). For example, the delta T or temperature differential between the water at the anodic inlet and anodic outlet may be at least 5° C., at least 10° C., at least 15° C., or at least 20° C. Similarly, the delta T or temperature differential between the water at the cathodic inlet and cathodic outlet may be at least 5° C., at least 10° C., at least 15° C., or at least 20° C. At the same time, the temperature differential or delta T between the lowest temperature and the highest temperature at the membrane (e.g., at a surface of the membrane) may be less than 5° C., less than 3° C., less than 2° C., or less than 1° C.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

The Abstract of the Disclosure is provided to comply with 37 C.F. R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the disclosure. The claims should not be read as limited to the described order or elements unless stated to that effect. Therefore, all embodiments that come within the scope and spirit of the following claims and equivalents thereto are claimed as the disclosure.

1. An electrochemical system comprising:
at least one electrochemical cell, each electrochemical cell of the at least one electrochemical cell comprising a cathode, an anode, and a membrane separating the cathode and the anode, therein defining a cathode side of the electrochemical cell and an anode side of the electrochemical cell;
an anodic inlet configured to receive a first supply of water to the anode side of the electrochemical cell;
a cathodic inlet configured to receive a second supply of water to the cathode side of the electrochemical cell;
an anodic outlet configured to transfer unreacted water and generated oxygen from the anode side of the electrochemical cell; and
a cathodic outlet configured to transfer water and generated hydrogen from the cathode side of the electrochemical cell,
wherein a flow of the first supply of water to the anode side of the electrochemical cell is in an opposite direction of a flow of the second supply of water to the cathode side of the electrochemical cell therein providing a counter-current flow arrangement between the flow of the first supply of water and the flow of the second supply of water.

2. The electrochemical system of claim 1, wherein the at least one electrochemical cell comprises a plurality of electrochemical cells in an electrochemical stack.

3. The electrochemical system of claim 2, wherein the plurality of electrochemical cells in the electrochemical stack is in a range of 50-1000 electrochemical cells.

4. The electrochemical system of claim 1, wherein the membrane of each electrochemical cell of the at least one electrochemical cell is a catalyst coated membrane.

5. The electrochemical system of claim 1, wherein a thickness of the membrane of each electrochemical cell of the at least one electrochemical cell is less than 1000 microns.

6. The electrochemical system of claim 1, wherein a thickness of the membrane of each electrochemical cell of the at least one electrochemical cell is in a range of 5-125 microns.

7. The electrochemical system of claim 1, wherein a reaction area of the membrane of each electrochemical cell of the at least one electrochemical cell is at least 500 cm².

8. The electrochemical system of claim 1, wherein a reaction area of the membrane of each electrochemical cell of the at least one electrochemical cell is in a range of 100-1000 cm².

9. The electrochemical system of claim 1, wherein each electrochemical cell of the at least one electrochemical cell is configured to operate at a current density of at least 3 Amps/cm² with 200 mV or less of pure resistive loss.

10. The electrochemical system of claim 1, wherein each electrochemical cell of the at least one electrochemical cell is configured to operate at a current density in a range of 5-10 Amps/cm² with 200 mV or less of pure resistive loss.

11. The electrochemical system of claim 1, wherein a flow rate of the second supply of water to the cathode side is in a range of 1-50% of a flow rate of the first supply of water to the anode side.

12. The electrochemical system of claim 1, wherein a temperature of the water at the anodic inlet and the anodic outlet is configured to have a temperature differential of at least 5° C. during operation of the electrochemical system,
wherein a temperature of the water at the cathodic inlet and the cathodic outlet is configured to have a temperature differential of at least 5° C. during the operation of the electrochemical system, and
wherein a temperature differential between a lowest temperature and a highest temperature at the membrane during the operation of the electrochemical system is configured to be less than 5° C.

13. The electrochemical system of claim 1, wherein a temperature of the water at the anodic inlet and the anodic outlet is configured to have a temperature differential of at least 10° C. during operation of the electrochemical system,
wherein a temperature of the water at the cathodic inlet and the cathodic outlet is configured to have a temperature differential of at least 10° C. during the operation of the electrochemical system, and
wherein a temperature differential between a lowest temperature and a highest temperature at the membrane during the operation of the electrochemical system is configured to be less than 1° C.

14. The electrochemical system of claim 1, wherein the electrochemical system is configured to provide a reduction in an amount of water provided to the electrochemical system defined by the first supply of water and the second supply of water in comparison to an amount of water required by an additional electrochemical system operating under similar conditions without any water supplied to the cathodic inlet.

15. The electrochemical system of claim 1, wherein the electrochemical system is configured to provide a reduction in an amount of water provided to the electrochemical system defined by the first supply of water and the second supply of water in comparison to an amount of water required by an additional electrochemical system operating under similar conditions having water supplied to the anodic inlet and the cathodic inlet in a co-current flow configuration.

16. The electrochemical system of claim 1, wherein the anodic inlet and the cathodic inlet of each electrochemical cell are positioned on opposite ends of the respective electrochemical cell.
